(19) United States
(12) Patent Application Publication
(10) Pub. No.: US 2005/0011959 A1
(43) Pub. Date: Jan. 20, 2005

(54) Tags and automated vision

(76) Inventor: David Arthur Grosvenor, South Gloucestershire (GB)

Correspondence Address: HEWLETT-PACKARD COMPANY;Intellectual Property Administration, P.O. Box 272400, Fort Collins, CO, 80527-2400, US

(21) Appl. No.: 10/868,241

(22) Filed: Jun. 15, 2004

(30) Foreign Application Priority Data
Jun. 25, 2003 (GB) 0314748.5

(51) Int. Cl. G06K 7/10; G06K 7/14

(52) U.S. Cl. 235/470; 235/454

(57) ABSTRACT

A system and method for processing images is provided. One embodiment is a method of processing an image comprising obtaining an electronic image from an input device, obtaining data concerning the properties of at least one object within the image by virtue of information encoded by tags associated with those objects and selecting at least one image processing procedure in accordance with the data indicated by the tags.

### FIELD OF INVENTION

Embodiments relate to the field of image processing, and more particularly to the use of tags to provide information to an automated image processing system such that the performance of the image processing can be augmented.

### DESCRIPTION OF PRIOR ART

A tag is a device, or label, that identifies an object (which can be regarded as a host) to which the tag is attached. The tag technology can be selected to be that appropriate to the environment in which the tag is to be used. Thus tags can be visual, chemical, audible, passive, active, radio transmitter based, infrared based and so on.

The use of tags within automated data processing systems has been disclosed by a number of workers. For example WO00/04711, incorporated herein by reference, discloses a system primarily for distributing wedding photographs. Each guest is given a visual tag to wear about their person which uniquely identifies them. Associated with each person's identify is their address. During the course of a wedding, a photographer takes a plurality of pictures of the guests. These are then automatically analysed by an image processing apparatus in order to identify which guest occurs within which photographs. Individuals can then be sent, electronically, copies of photographs in which they occur. The application also discloses that the tags may be used within an augmented reality system such that a user wearing an audio or visual aid may receive additional information about a third party whose identity has been established by virtue of analysis of their tag. Thus this system discloses the use of tags to convey identity information. However no disclosure is made of the use of tags to enhance the performance of an image analysis system.

Workers have also disclosed that tagging may be used to help deduce the orientation of an object with respect to a camera. The tags may include indicia thereon which can be used to convey the relative orientation of an object with respect to a camera such that an automated recognition system involving 3D models can significantly reduce its search space for object identification. In this system the image processing system already has knowledge of the object it is viewing and the tag only conveys orientation information.

The use of low resolution tags readable by multipurpose video cameras of the type implemented on personal computing devices is also discussed in “cybercode: Designing Augmented reality environments with visual tags”, Jun Rekimoto and Yuji Ayatsuka, Interaction Laboratory, Sony Computer Science Laboratories Inc., www.csi.sony.co.jp/person/rekimoto.html, incorporated herein by reference. This system discloses that the tags can be pointers to a database record for providing additional information about an object or its environment in an augmented reality environment.

The use of active tags having built-in sensing is briefly discussed in “Ubiquitous Electronic Tagging” by Roy Want of Xerox PARC and Daniel Russell of IBM Almaden Research Center, incorporated herein by reference. They indicate that one wire interface button tags from Dallas Semiconductor already offer the ability to measure temperature to within 0.5° C. and to store up to 1 million entries before uploading the data.

### SUMMARY OF INVENTION

Briefly described, one embodiment is method of processing an image comprising obtaining an electronic image from an input device, obtaining data concerning the properties of at least one object within the image by virtue of information encoded by tags associated with those objects and selecting at least one image processing procedure in accordance with the data indicated by the tags.

### BRIEF DESCRIPTION OF THE DRAWINGS

The present invention will further be described, by way of example, with reference to the accompanying drawings, in which:

FIG. 1 schematically illustrates a person wearing a tag within the field of view of an image processing system constituting an embodiment of the present invention;

FIG. 2 schematically illustrates the form of a visual tag;

FIG. 3 schematically illustrates the form of an active tag constituting an embodiment of the present invention;

FIG. 4 illustrates the processing steps undertaken in accordance with a method constituting an embodiment of the present invention; and.

FIG. 5 is a flowchart illustrating a process used by an embodiment to process images.

### DETAILED DESCRIPTION

Whilst the use of tags to convey information about an object, i.e. a tag on a person, has been used to convey information about that person's name and address, the above-described tags have not been used as an aid to automated processing of images in such a way as to allow the image processor to select an appropriate image processing procedure.

In one embodiment, there is provided an image processing system comprising a camera and a data processor responsive to an output of the camera, wherein the image processing system is further responsive to tags carried on associated objects within the field of view of the camera. The tags provide information about the associated object which is used by the image processing system to modify its processing of the camera output. The data processor can implement a plurality of image processing procedures. Data from the tag is utilised to determine which procedures are appropriate.

It is thus possible to use a tag on an object to convey a priori information to the image processing system such that it can modify the procedures which it implements. It is also possible to provide an automated image processing system which can select a suitable image processing procedure or suitable model of an object in order to enhance image analysis as a result of data provided by the tag.

In one embodiment, the tag encodes information concerning the object as part the tag. The tag may for example encode generic information such as genus, class, type or identity of an object, for example identifying a tagged object as human or an automobile. The tag may additionally and/or alternatively encode object specific information. Thus, if the tag is a passive device it may be necessary to perform some information capture prior to generation of the tag. For example, if a person arrives at a venue where tagging is used, for example a party, a conference, a theme park or the like, that person may need to undergo some pre-processing before a tag is issued to them. The tags may encode basic information such as their gender and their age as this information can be used in order to deduce possible visual features which may be of use to an image analysis program when trying to identify an individual within a complex scene. Thus, children tend to be shorter than adults and women tend to have a different body shape than men. The tag may also encode other information such as the colour and quantity of an individual's hair, the colour of their clothes and so on.

The system operator or designer has the choice of how little or how much information they choose to capture about an individual, but in the case of purely visual tags, the designer may be limited by the amount of information that they can encode on a tag while still achieving an acceptable tag size and image recognition distance. Therefore, rather than encoding information directly, the tag may act as a pointer to an information repository. For example, the tag may point to a record in a database where information about a particular object can be held. Thus, larger and more detailed descriptions of the object can be held for use by the recognition system. When faced with an object, the image recognition system can initially identify the tag, and from that look up the record associated with the object to obtain information concerning the object, such as its physical and/or visual properties. The system may thereby select an image processing algorithm or object model appropriate to identifying the object or features thereof, from a complex background.

Because of the complex nature of the environment, the identification of a tag in a scene merely indicates that to a high probability (in case the tag has become removed from its object or another object has tag like regions on it) the tagged object exists in the scene. However the tag itself does not convey data identifying which pixels of the image the object exists in, nor the pose and/or orientation of the object with respect to the camera.

Thus the search and identification techniques for detecting specific objects or classes of objects need to be able to deal with the uncertainty in the pose, orientation and size of objects presented in the image. Also, objects may be partly obscured. Object identification “engines” may be implemented using statistical analysis, learning algorithms such as neural nets and support vector machines are suitable candidates for such identification engines.

Currently object detection is performed using two main approaches. A first approach is based on identification of local features, or “representation-by-parts.” Thus an object is decomposed into further objects. For example, a face might be identified by finding the eyes and the mouth and using configuration constraints to detect plausible facial patterns.

A second approach is a holistic approach which seeks to search for an object in its entirety.

The goal of statistical learning, or statistical analysis is to estimate an unknown inference from a finite set of observations.

Such a learning/analysis machine usually implements a family of functions. The functions are typically regression, classification, probability or density functions. The functions may be implemented within the neural networks based upon multilayer perceptions, radial basis functions, linear discriminant functions, polynomial functions, gaussian density functions and/or mixture density models.

A learning algorithm may also be employed in one embodiment. The algorithm normally employs a method of model estimation usually based upon optimisation to minimise some approximation to the expected risk.

In another embodiment, the tag may be arranged to transmit the most appropriate image processing algorithm for the associated object, or provide some means to directly identify the most appropriate algorithm to select.

It is possible that in a complex and changing environment, such as a theme park, that parts of a tag or parts of an object, such as a person tagged by the tag would be obscured. It is therefore advantageous to encode information concerning other objects or environmental information that is likely to be associated with the tagged object. Thus, if it is known that a man and a woman constitute husband and wife, then they can be associated with each other in the image processing system such that, if one is identified in an image, a search may then be made for the other. Indeed, if a tag is located but the object, for example the husband, is partially obscured by another object, then the image processing system can initially check the nature of that other object to see if it corresponds to the physical properties of his wife. This may then allow images of the husband and wife to be extracted from the complex background.

In one embodiment, an object may be tagged with more than one tag. This may help in identifying the orientation of an object. Thus, if the object is a spatially well defined item, such as a car or other rigid object, two tags may be sufficient to uniquely define its orientation in space if the position of each tag on the object is also well defined. If the object is capable of exhibiting more than one configuration, for example the object is a person and hence can bend at various joints, then multiple tags may still be beneficial in helping to identify the orientation of that person. Furthermore, the relative positions of the tags on the person can help the image processing system to identify features of that person, which features themselves are not tagged. Thus, if a tag is provided on a person's wrist, then the image processing system having identified the wrist, can use information of the fact that the fingers will be in relatively close proximity to the wrist, and indeed in the real world are likely to be within 15 or 20 cm from the wrist, and may then use an image processing procedure or algorithm especially suitable for the identification of fingers within a search space identified with reference to the wrist tag.

In one embodiment the tag is a visual tag. This allows the camera recording the scene to function as the input device extracting information from the tags. The tags may be arranged to encode information such that the tags are visible within the part of the electromagnetic spectrum corresponding to human colour vision. Such tags can be used with readily available cameras.

Alternatively, where the intrusion of the tag is not visually acceptable, the tag may be arranged to be “visible” outside the normal range of human colour vision. Thus the tag may encode information within the ultraviolet or infrared regions of the electromagnetic spectrum, and a suitable camera or other detector device may be needed to detect such tags.

As a further alternative, the tag may be a radiative device and hence may be positioned discreetly about the person. Thus, the tag may include a radio transmitter and transmit an identity code uniquely identifying the tag and/or encode data relating to the physical properties and/or appearance of an object tagged with the tag. Alternatively the tag may emit radiation, such as infrared light or ultrasound, which may be modulated to convey the tag identity. Where the tag is an active transmitter but is visible to a camera, the image processing system can capture the information from multiple tags easily as they appear spatially separated in the image. The image processing system may also seek to capture images of the area around a tag when the tag is not actively transmitting (that is, if the tag transmits data by virtue of pulsing a light emitting device on and off, then images can be captured during the off part of the transmission) such that the presence of the tag can be removed or masked in an image, or such that it's visibility to the observer is attenuated.

Preferably the tag further includes one or more sensors responsive to environmental conditions. This may be relevant as the environmental conditions may allow information to be deduced concerning the likely appearance of the object that is tagged. Thus, for example, at sunset objects will tend to appear redder than is normally the case at midday. Furthermore on warm days people tend to be redder and more sweaty than is the case on cold days. Temperature fluctuations and lighting fluctuations can occur very quickly. Consequently, this data may need to be updated dynamically in order that the same object can be rapidly identified by the processing system with the minimum amount of computational overhead. Similarly, data such as humidity and wind speed can also be used to determine whether or not an individual is likely to look wet or windswept. If the encoded information includes the colour of a tag wearer's clothing, for example a coat, a jumper and a shirt, then environmental information may also be used to determine which of the garments is most likely to represent the outer layer of their clothing at any given time. Thus, on a hot day an individual is unlikely to be wearing their coat, although they may have brought it with them since at the time of entering the event it may have been much colder.

The image processing system may compare images of a scene separated at moments in time in order to determine the motion of objects within that scene. Thus, if the tag includes motion detectors it may be able to provide information concerning the speed at which an individual is moving and possibly their direction. This can be correlated with the views from the camera in order to aid identification of the correct target. The tag may also be responsive to the relative orientation of an object and the position of parts thereof. Thus, if the object tagged is a person, the tag may be able to indicate whether they are standing, sitting or lying down. This, once again, is useful information to the image processing system in its attempt to identify the correct object, and to process information relating to that object correctly.

In one embodiment the automatic image processing system is arranged to identify objects of an image by implementing processes such as segmenting and grouping. In order to enhance the speed and reliability of these processes, the image processing system uses the data supplied by the tag in order to select an appropriate model relating to the object, and may also use information relating to the physical appearance of the object in order to correctly associate the component parts of the object with that object.

This additional information can be computationally significant. Thus, in a prior art image processing system utilising segmentation, if the tag was worn by a person, and the tag was on that person's jumper and the jumper was blue, then having identified the tag the image processing system would tend to segment the image by following the blue area and hence would identify the outline of the jumper, but not the rest of the person. However by utilising additional information (provided by the various embodiments) of the person's skin tone, hair colour and colour of other items of clothing, the segmentation process can be extended to analyse adjacent regions of colour in an attempt to correctly identify the extent of the person within the image.

An alternative but related approach to segmentation is that of grouping together regions within an image that comprise an object. The regions that compose an object move around with the object and it is therefore easier to define the object as a group of regions. This approach is particularly applicable to articulated objects, such as people and animals, where although the overall shape of the object may be quite variable, it can be defined in terms of the relationship between different regions of the object. Hence a tag associated with an object may define the regions that compose the object and their relationship to one another.

Another segmentation technique is that of using probabilistic shape models. This technique comprises selecting an appropriate template, or object outline, and fitting it to an image to identify the outline of an object. By varying one or more parameters, the template assumes an “elastic” property allowing it to be “stretched” to closely fit the presented object image. Hence, information conveyed by a tag may be used to better select the appropriate template and those parameters most likely to vary.

Active contour models are examples of probabilistic shape models. These models develop a probalistic model maintaining multiple hypotheses about the interpretation of the image data. Active contour models can be developed or trained for particular objects or particular motions and are thus particularly useful in applications involving the tracking or an object. Although active contour models will be familiar to the person skilled in the art, further information can be found by reference to the book “Active Contours—the application of techniques from graphics, vision, control theory and statistics to visual tracking of shapes in motion” by Andrew Blake and Michael Isard (pub. Springer 1998), incorporated by reference herein.

The use of tags in the various embodiments to aid object tracking need not be limited to application using probabilistic shape or active contour models. The simple expedient of providing physical information about an associated object may be used to improve tracking performance.

In one embodiment tags may also include information relating to the environment in the field of view of a camera. Thus, a building may be tagged. Optionally a tag may be included within a field of view in order to convey specific information about the general nature of the background. Thus tags may be used to indicate whether the background is an urban background, whether it is wooded, a beach or so on. The nature of the background may impact on the computational complexity of identifying the boundary of an object within the image.

In one embodiment, a tag provides information identifying an information repository about an object. Each time the object is captured and identified by the image processing system, the information in the repository relating to that object is checked and, if necessary, updated.

In one embodiment, the camera may be static or may be mobile. Static cameras may nevertheless be controllable to perform operations such as panning and tilting. The camera, whether mobile or static, may be part of an image capture system for presenting “photographic” style images to a user. Thus, the images will tend to need to be composed “correctly.” The camera may be arranged to capture more information from a scene than will be used in the final image. Thus, the image from the camera may be subjected to post capture processing, for example by performing tilt correction, zooming, panning, cropping and so on in order to include only selected items within the image and to exclude non-desirable items within the image.

Both selected items, and non-desirable items, may be marked by tags. Thus if it is desired to capture a specific individual within a photograph, the system may be instructed to look for that specific individual by virtue of identifying their tag. Once the tag has been located, a model concerning that person and including attributes such as colour of clothes, colour of skin, colour of hair and so on may be recalled from a database such that a suitable segmentation algorithm can be implemented in order to determine the boundary of that person within the image based on the position of the tag, which necessarily marks a point in the image where that person can be found. Also, information about that person in the image may be further analysed in order to locate the person therein. Once this has been achieved further post image capture processing may then be implemented in order to derive suitable crop boundaries relating to the subject. For example, if it is desired to take a photograph of a person's head and shoulders, and this information is supplied to the image processing apparatus, the image processor may implement a head identification model and search the image space around the tag in order to identify the wearer's head.

In one embodiment the system may also be responsive to other conditions input by a user or operator. For example, in one embodiment, the system may only select images where two specific tags are in the picture, and optionally may further require that these correspond to predetermined rules of image composition. An example of where this may be used is at a zoo where it may be deemed desirable to obtain pictures where a tagged individual is shown in conjunction with a tagged animal.

In one embodiment, where a scene is selected, the raw data pertaining to that scene may also be stored for subsequent post processing. Thus, where a series of images were taken such that an object was included, later post-processing may be performed in order to remove that object. Images may therefore be re-manipulated several years after they were captured. Supposing a trip to a funfair had been recorded and several images from that trip included views of a husband, a wife and one or more children and that the parents subsequently divorced. The image may be re-analysed in order to identify the husband and wife within the picture. The image may be re-cropped in order to remove an unwanted spouse in subsequent image processing. In addition to or as an alternative to a re-cropping, further image processing may then be performed in order to synthesise a suitable replacement background and/or to insert another person. The automatic identification of the offending object and the boundaries thereof simplifies this re-composition process.

For systems using visual tags, or infrared tags in association with cameras having infrared automatic focusing systems, the position of the tagged object within the camera's field of view is easily determined. However, for systems employing radio tags or using detectors which are not mounted on or adjacent the camera, it will be further necessary to perform a spatial processing step of triangulating the position of the tag using at least two tag detectors. Another embodiment further transforms this position into a new target co-ordinate with respect to the camera.

According to a second aspect of an embodiment, there is provided a method of processing an image. The process may comprise obtaining an image from an input device, obtaining data concerning the properties of at least one object within the image by virtue of data encoded by tags associated with those objects, and selecting image processing in accordance with the data conveyed by the tags.

According to a third aspect of an embodiment, there is provided a computer program product for causing a data processor to implement the method according to the second aspect.

According to a fourth aspect of an embodiment, there is provided a tag for use in an image processing system wherein the system comprises a plurality of image analysis procedures and wherein the tag encoded with physical features of the object or is responsive to physical features of the object or the environment around the object and provides information concerning the physical features of the object or the environment to the image processing system such that the system can select an appropriate image analysis procedure.

In some embodiments, the tag actively transmits data concerning the object or the environment such that this data is available at the time of capturing or analysing the image. Sensors may indicate the orientation of the tagged object. Thus, information may be provided as to whether the object is facing directly towards the camera, or is oblique to it, side on and so on. Information may also be provided concerning whether the object, for example a person, is standing, sitting or lying down.

In some embodiments, where the environment includes lots of tagged objects, an active tag may also include data including the identities of other tagged objects near it. This information can be used to enhance the image analysis since not only is information provided about the tagged object, but also significant amounts of other information can be provided about adjacent objects such that these objects can also be correctly identified in the image.

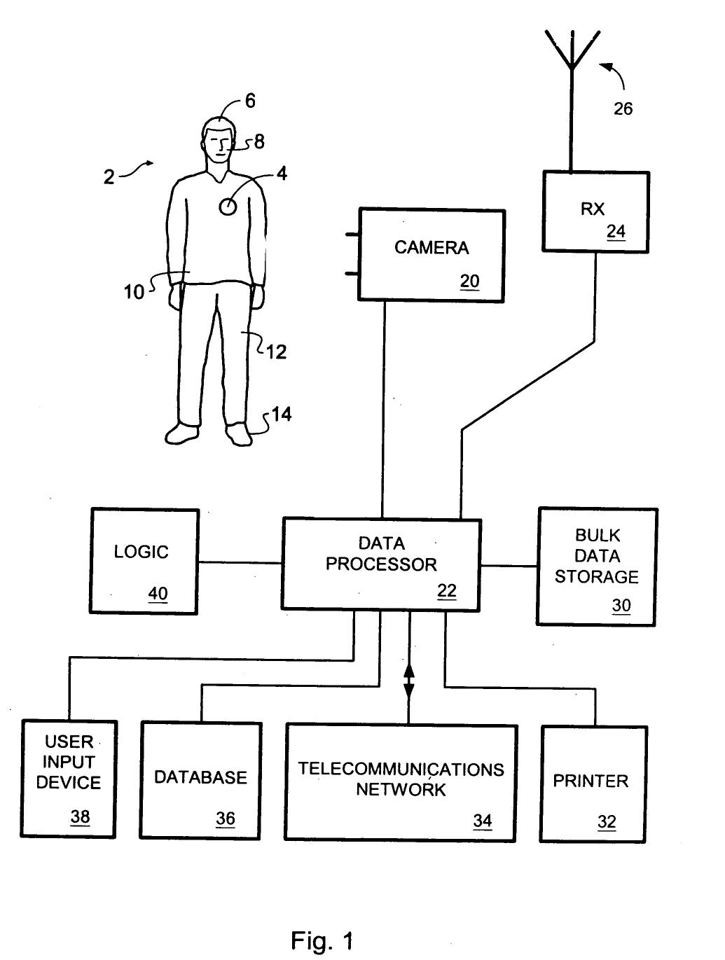

FIG. 1 schematically illustrates an image processing system in which an object has a tag 4. In this example, person 2 is marked with a tag 4 which encodes information concerning the physical and visual properties of the person 2. The tag 4 need not encode the information directly, but could indicate a pointer towards a record in a database which holds information concerning the person 2. Accordingly, the tag 4 could indicate (convey) the data directly by using information on the tag. Alternatively, the tag 4 could indicate the data indirectly by pointing to the data residing in a remote location, such as in a processor-accessible database storage medium. Here, tag information is used to indicate the location of the data (point) residing in the remote location.

For example, the information encoded by the tag or in the database could indicate the colour of hair 6 of the person 2, their skin tone 8, the colour of their clothing 10, whether they are wearing trousers 12 (or optionally shorts or a skirt and so on) and the colour of the trousers, and the colour of the shoes 14. The tag 4 can also encode further data. For example, in this instance that the tag 4 is attached to a person 2, the tag may optionally include information about the person's age and gender. The tag 4 can equally be attached to other objects, such as buildings, cars, street furniture, animals and so on.

One embodiment of an image processing system comprises a camera 20 which is used to view a scene and which generates an electrical representation of the scene. The camera can be implemented using any suitable technology, and may therefore be a charged coupled device camera as these are available relatively cheaply with low power consumption. The camera 20 provides a video output to a data processor 22. For systems where transmissive tags may be used, such as radio tags, the data processor 22 may also be responsive to a radio receiver 24 which in turn is connected to an antenna 26 for picking up the transmissions from the tag 4. The data processor 22 may interface with one or more devices. Thus the data processor 22 may interface with a bulk storage device 30, a printer 32, a telecommunications network 34, a database 36 and a user input device 38 which may for example be a keyboard.

It should be noted that not all of these connections or components need be concurrent and/or external. Thus an embodiment of a portable camera may include a bulk memory device and a data processor for controlling the operation of the camera. The data processor may also be arranged to perform some image processing. For example, tag recognition processing may be done such that pictures may be taken and stored only when they match certain criteria as defined by the user.

In one embodiment, only at a later stage may full image analysis be performed, possibly on a different data processor.

In use, the camera captures sequential images of the field of view in front of the camera and provides these to the data processor 22. The data processor 22 may then implement a first search procedure to identify tags in the image, given that the physical characteristics of the visible tags are, to a large extent, well defined.

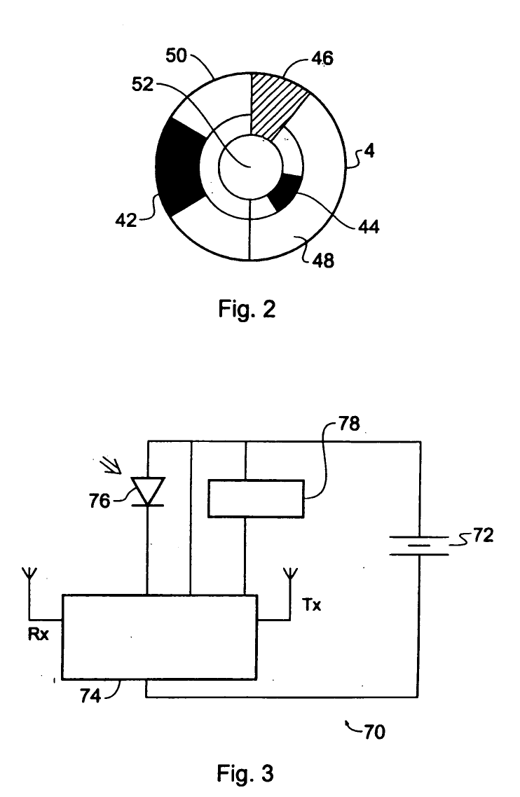

FIG. 2 schematically illustrates an embodiment of a visible tag 4. The tag 4 constitutes a radially and angularly segmented disc with the segments 42, 44, 46 and 48 being of different colours, sizes and position thereby encoding data in accordance with a predetermined coding scheme. The disc may be provided with a monotone border 50, possibly in conjunction with a central “bulls-eye” portion 52 in order to provide a template for recognition of the tag 4.

Once the tag 4 has been identified, or in the case of radiative systems the signal from the tag 4 has been picked up by antenna 26 and demodulated by a receiver 24 and then supplied to data processor 22, the data processor 22 uses the tag identity code to query a database 36 in order to extract additional information concerning the object 2 (FIG. 1). The database 36 may have been populated with information concerning the object 2 by a system operator using the input device 38 at the time of issuing the tag for the user 2. Additionally and/or alternatively the user may have passed through an “input station” where an image of the object 2 was captured and was subjected to an analysis by a more powerful image processing system (or one having more time) in order to extract data concerning the object 2, and possibly also data concerning the type of model to represent the object with. In this specific example where the trousers 12 and the top 10 (FIG. 1) of the person 2 are of different colour, and the person may be represented by a four segment model (trousers, top, face and hair) or a three segment model (if the trousers are the same colour as the top).

The database 36 need not be directly connected to the data processor and may be a remote database accessed via the telecommunications network 34 (FIG. 1). The data processor 22 can save images received from the camera 20, either before or after processing, to the bulk store 30, and may also arrange for images to be printed by a printer 32, either before or after processing. As noted hereinbefore, the system may use an active, that is radiative, transmitter.

FIG. 3 schematically illustrates an embodiment of a tag transmitter 70. The transmitter 70, comprises a power source, such as battery 72, for supplying power to an onboard data processor and transmitter 74. The data processor 74 is responsive to several input devices. In this exemplary embodiment, an optional light dependant transducer, such as a photo diode 76, is provided in order to determine the ambient lighting level. Although only one photo diode 76 is shown, several photo diodes in association with respective filters may be provided in order that the general “colour” of the ambient light can be determined. It is thus possible to distinguish between bright daylight, sunset and artificial light. A position sensor, such as a solid state gyroscope 78, may optionally be provided such that the motion and/or orientation of the tag, and hence the object to which it is attached, can be determined. The data processor 74 may optionally include a receiver such that it can identify other tags in its vicinity.

It is possible that an embodiment of a tag can operate in a “whisper and shout” mode in which it transmits data for reception by the camera 20 (FIG. 1) or the aerial associated with the vision system at relatively high transmitter powers, and transmits data for reception by other tags at much lower transmitter powers, or by a short range medium such as ultra sonic transmission, such that each tag is able to identify its nearest neighbours, but only its nearest neighbours. This relational information can then be transmitted to the image processing system. This could be particularly advantageous where, for example, the person 2 (FIG. 1) has moved into the vicinity of a highly reflecting surface, but the reflecting surface is itself tagged. This would enable the image processing system to be warned that it might find two representations of the person in an image, and that one of them will be a reflection.

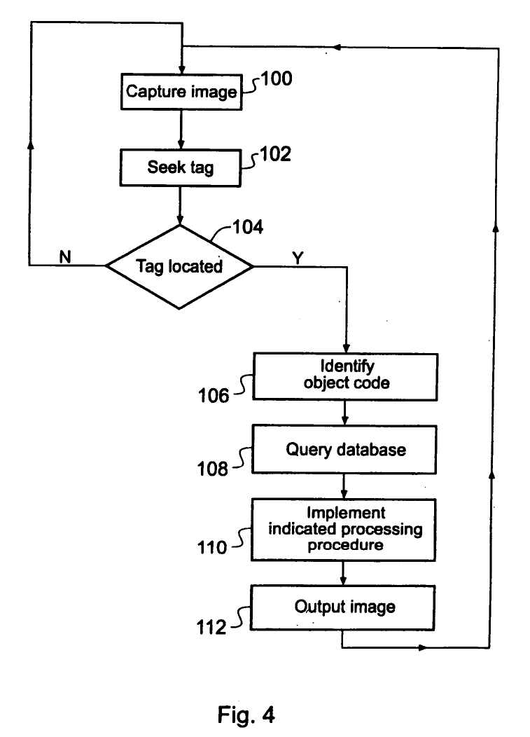

FIG. 4 schematically illustrates an exemplary process undertaken within an embodiment of the present invention utilising the visible tag 4 (FIG. 1). Commencing at step 100, the camera captures an image of the scene in front of it. The image is digitised and passed to the data processor 22 (FIG. 1) which then analyses the image at step 102 to seek one or more tags therein. Control is then passed to step 104 where a test is performed to see if any tags 4 were located. If no tags 4 were located then control is returned to step 100. However, if a tag 4 has been located, then control is passed to step 106 where the image of the tag is analysed more carefully in order to determine its identity code. Having determined the unique code presented by the tag 4, control is passed to step 108 where an object data base is queried in order to obtain additional information about the physical and/or visual properties of the object associated with the tag. Step 108 can be omitted, or indeed supplemented, by information provided directly by the tag 4 where the tag 4 itself encodes physical and/or visual properties of the object attached to it. Having queried the database, the appropriate image processing scheme is initiated at step 110 and the image output at step 112. The output image may be passed to another procedure (not shown) or printed or stored in mass storage. From step 112 control is returned to step 100.

The image processing steps or model implemented as part of the image analysis are known to the person skilled in the art and need not be described here in detail. However it is important to note that the tag 4 provides data and/or access to data concerning objects in the image. The data is used by the data processor during image analysis, thereby allowing it to select appropriate image processing techniques, and saving it from being burdened by trying inappropriate analysis steps. For the sake of illustration, one example will be given with reference to the FIG. 1 embodiment.

The user's tag 4 contains a reference (this may simply be an identity code) to a record of a preferred colour value or set of colour values of the user's skin tone 8. This reference is detected by the processor 22 in step 106, the processor 22 consulting the database 36 in step 108 to obtain the user's preferred skin tone values. These skin tone values are used in step 110 in a colour transformation of the image—the skin regions of the image detected through camera 20 are identified (advantageously, just those skin regions that are in the vicinity of or otherwise associated with the tag 4) and their colour values determined, and the image as a whole or just appropriate regions of it are colour transformed so that the skin regions in the vicinity of the tag take on the colour values for skin tone preferred by the user. The resulting transformed image is that output in step 112 (FIG. 4). The resulting image can then be provided for example for printing by printer 32, provided for storage in storage device 30, or displayed for further manipulation by the user through user interface 38.

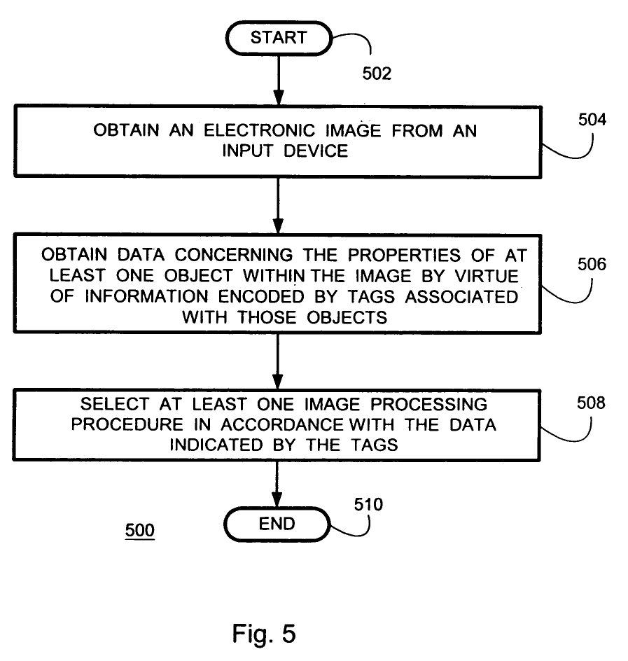

FIG. 5 is a flowchart 500 illustrating a process used by an embodiment to process images. The flow chart 500 shows the architecture, functionality, and operation of a possible implementation of the software for implementing the logic 40 (FIG. 1) for processing images. In this regard, each block may represent a module, segment, or portion of code, which comprises one or more executable instructions for implementing the specified logical function(s). It should also be noted that in some alternative implementations, the functions noted in the blocks may occur out of the order noted in FIG. 5 or may include additional functions. For example, two blocks shown in succession in FIG. 5 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process starts at block 502. At block 504, an electronic image from an input device is obtained. At block 506, data concerning the properties of at least one object within the image by virtue of information encoded by tags associated with those objects is obtained. At block 508, at least one image processing procedure is selected in accordance with the data indicated by the tags. The process ends at block 510.

In image processing systems where the number of image processing models or procedures is finite but well defined, one embodiment of a tag 4 (FIG. 1) could encode an identity of the image processing model that is to be used. Indeed, this can be inferred directly from the tag identity if certain attributes of the tag are well defined. Thus, if the tag indicates that it is a wrist tag (that is tag worn on the user's wrist) or a head tag (for example a small infrared transmitter placed in a user's cap or worn as a unit clipped to their ear), then the data processor can use this information to instigate algorithms for identifying hands or faces as appropriate.

It is thus possible to provide an image processing system, and a tag for use in the image processing system, which enables digital data concerning the tagged object to be provided to the image processing system prior to image analysis such that an appropriate image analysis algorithm or routine can be implemented, thereby enhancing accuracy and throughput.

1. An image processing system comprising:
a camera; and
a data processor responsive to an output of the camera, wherein the image processing system is further responsive to a tag carried on an associated object within a field of view of the camera, the tag providing information about the associated object which is used by the image processing system to modify its processing of the camera output, and wherein the data processor implements a plurality of image processing procedures, and wherein data associated with the tag information is utilised to determine which of the image processing procedures are appropriate.

2. The image processing system of claim 1, wherein the data associated with the tag information indicates an image processing procedure to be implemented by the data processor.

3. The image processing system of claim 1, in which the tag information indicates data concerning a physical nature of the object.

4. The image processing system of claim 3, in which the tag information indicates at least one of a genus, a class, a type and an identity of the object.

5. The image processing system of claim 3, in which object identification activities are invoked according to object information supplied by the tag information.

6. The image processing system of claim 3, wherein one of a plurality of object identification algorithms is selected on the basis of the tag information.

7. The image processing system of claim 3, wherein one of a plurality of object models is selected on the basis of the tag information.

8. The image processing system of claim 3, wherein the tag information indicates data concerning a visual appearance of the object.

9. The image processing system of claim 3, in which the image processing system uses data concerning a visual appearance of the object during processing.

10. The image processing system of claim 9, in which the object comprises a person and the data concerning the visual appearance of the person includes at least one of a person's race, a person's gender, a person's size, a person's clothing worn, a person's hair colour, a person's hair style, a person's jewellery and a person's spectacles.

11. The image processing system of claim 1, in which the tag conveys the data which is used by the image processing procedures.

12. The image processing system of claim 1, in which the tag points to the data which is used by the image processing procedures.

13. The image processing system of claim 1, in which the data used by the image processing procedures constrain a selection of models used.

14. The image processing system of claim 1, in which the data used by the image processing procedures constrain a selection of image analysis algorithms used.

15. The image processing system of claim 1, in which the data is used to rank a plurality of image processing models used to identify features within an image.

16. The image processing system as claimed in any one of claim 1, in which the data is used to rank a plurality of image processing algorithms that may be used to identify features within an image.

17. The image processing system of claim 1, wherein the tag indicates data enabling the data processor to perform an image segmentation process.

18. The image processing system of claim 1, wherein the tag indicates region grouping data enabling the data processor to associate regions that compose an object.

19. The image processing system as claimed in claim 1, in which the tag indicates data for a selection of an object template for use in an identification model.

20. The image processing system of claim 1, in which the tag indicates information about the environment and the image processing system uses this environment information during its processing of the camera output.

21. The image processing system of claim 1, wherein the image processing procedures include probabilistic shape models.

22. The image processing system of claim 21, wherein the probabilistic shape models are trained during image processing.

23. The image processing system of claim 1, wherein the tag indicates data facilitating the ability of the data processor to perform tracking of the associated object.

24. The image processing system of claim 1, in which the tag identifies a data store for holding data about the associated object.

25. The image processing system of claim 24, in which each time an object is captured and analysed by the image processing system, the data relating to the object is updated.

26. The image processing system of claim 1, wherein the image processing system further comprises a plurality of cameras.

27. The image processing system of claim 1, wherein the tag indicates the information concerning the tag's position on an object, and the image processing system uses this position information to invoke a particular image processing process for part of the object in a predetermined relationship with respect to the tag.

28. The image processing system of claim 1, further comprising a radio receiver responsive to a radio transmitter in the tag, wherein the information is communicated from the tag transmitter to the radio receiver.

29. A method of processing an image, comprising:
obtaining an electronic image from an input device;
obtaining data concerning the properties of at least one object within the image by virtue of information encoded by tags associated with those objects; and
selecting at least one image processing procedure in accordance with the data indicated by the tags.

30. The method of claim 29, further comprising capturing the electronic image wherein the tags are visible on the image.

31. The method of claim 29, further comprising analysing the electronic image to identify the tags thereon.

32. The method of claim 29, further comprising receiving transmitted information from the tag, the information having at least identity data, such that the information pertinent to image analysis of the tagged object can be obtained from a data store.

33. The method of claim 32, further comprising transmitting by the tag information appertaining to the image processing procedure to be used to identify the object.

34. The method of claim 33, wherein obtaining the data further comprises obtaining a probabilistic shape model relating to the object.

35. The method of claim 32, wherein the receiving further comprises receiving information concerning at least one of a motion, an orientation or a pose of the object.

36. The method of claim 32, wherein the receiving further comprises receiving information to facilitate tracking of the object.

37. The method of claim 29, wherein the selecting further comprises constraining the image processing procedure.

38. The method of claim 29, further comprising adjusting colour of a portion of the object based upon the tag information.

39. The method of claim 29, further comprising adjusting orientation of the object based upon the tag information.

40. The method of claim 29, further comprising adjusting position of the object based upon the tag information.

41. The method of claim 29, further comprising determining associated information pertaining to the object based upon the tag information.

42. A tag for use in an image processing system, wherein the tag is encoded with or is responsive to physical features of an object to which the tag is attached, wherein the tag is responsive to the environment around the object, and wherein the tag indicates information to the image processing system such that the image processing system can select an appropriate image analysis procedure from a plurality of image analysis procedures.

43. The tag of claim 42, the tag further comprising visual information concerning the object encoded as part of the tag.

44. The tag of claim 42, the tag further comprising address information pointing to an address where information concerning the object is available.

45. The tag of claims 42, wherein the information comprises information relating to at least one physical property of the object.

46. The tag of claim 45, wherein the information comprises information relating to an appearance of the object.

47. The tag of claim 42, wherein the information comprises information relating to other objects that have a significant probability of being in the vicinity of the tagged object.

48. The tag of claim 42, wherein the information comprises information relating to a position of the tag on the object.

49. The tag of claim 42, wherein the information of the tag is detectable in an infrared or an ultraviolet region of an electromagnetic spectrum.

50. The tag of claim 42, wherein the tag further comprises a transmitter.

51. The tag of claim 50, in which the tag is responsive to one or more of:
a. an ambient lighting parameter;
b. an ambient temperature parameter;
c. an ambient humidity parameter; and
d. a wind speed parameter,
wherein the tag transmits data concerning one or more of the parameters.

52. The tag of claim 50, in which the tag is responsive to a motion of the object, and wherein the tag transmits information relating to the motion.

53. The tag of claim 50, in which the tag is responsive to an orientation of the object, and wherein the tag transmits information relating to the orientation.

54. The tag of claim 50, where the tag is responsive to the proximity of other tags, and is arranged to transmit data pertaining to other tags in its vicinity.

55. A system for processing an image, comprising:
means for obtaining an electronic image from an input device;
means for obtaining data concerning the properties of at least one object within the image by virtue of information encoded by tags associated with those objects; and
means for selecting at least one image processing procedure in accordance with the data indicated by the tags.

56. The system of claim 55, wherein the means for obtaining data further comprises means for obtaining proximity information from the tag when the tag is responsive to the proximity of other tags and when the tag is arranged to transmit the proximity information pertaining to other tags in its vicinity.

57. The system of claim 55, wherein the means for obtaining data further comprises means for obtaining address information form the tag pointing to an address where information concerning the object is available.

58. The system of claim 55, wherein the means for obtaining data further comprises means for obtaining information from the tag relating to at least one physical property of the object.

59. The system of claim 55, wherein the means for obtaining data further comprises means for obtaining appearance information from the tag relating to an appearance of the object.

60. The system of claim 55, wherein the means for obtaining data further comprises means for obtaining information from the tag relating to other objects that have a significant probability of being in the vicinity of the tagged object.

61. The system of claim 55, wherein the means for obtaining data further comprises means for obtaining position information from the tag relating to a position of the tag on the object.

62. The system of claim 55, wherein the means for obtaining data further comprises means for obtaining motion information from the tag when the tag is responsive to a motion of the object.

63. The system of claim 55, wherein the means for obtaining data further comprises means for obtaining orientation information from the tag when the tag is responsive to an orientation of the object.

64. A program for processing an image stored on computer-readable medium, the program comprising logic configured to perform:
obtaining an electronic image from an input device;
determining data concerning the properties of at least one object within the image by virtue of information encoded by tags associated with those objects;
selecting at least one image processing procedure in accordance with the data indicated by the tags; and
processing the electronic image in accordance with the selected image processing procedure.

65. The program of claim 64, wherein the program further comprises logic configured to adjust colour of a portion of the object based upon information from the tag.

66. The program of claim 64, wherein the program further comprises logic configured to adjust orientation of the object based upon information from the tag.

67. The program of claim 64, wherein the program further comprises logic configured to adjust position of the object based upon information from the tag.

68. The program of claim 64, wherein the program further comprises logic configured to determine associated information pertaining to the object based upon information from the tag.
